(19) United States
(12) Patent Application Publication
(10) Pub. No.: US 2025/0273229 A1
(43) Pub. Date: Aug. 28, 2025

(54) ELECTRONIC DEVICE AND METHOD THEREOF

(71) Applicants: Hyundai Motor Company, Seoul (KR); Kia Corporation, Seoul (KR)

(72) Inventors: Hyun Sik Choi, Seongnam-si (KR); Eui Hyeok Lee, Gimpo-si (KR)

(21) Appl. No.: 18/742,185

(22) Filed: Jun. 13, 2024

(30) Foreign Application Priority Data
Feb. 28, 2024 (KR) 10-2024-0029183

(51) Int. Cl. G10L 21/0364; G10L 15/08; G10L 15/22; G10L 21/0208; G10L 21/0216; G10L 21/034

(52) U.S. Cl. CPC G10L 21/0364; G10L 15/08; G10L 15/22; G10L 21/0216; G10L 21/034; G10L 2015/088; G10L 2021/02082; G10L 2021/02166

(57) ABSTRACT

An electronic device may include a plurality of microphones, a speaker, a processor, and a memory. The processor may be configured to obtain a plurality of voice signals by using the plurality of microphones, to identify a designated call word, by performing speech recognition on a first voice signal obtained from a first microphone, from among the plurality of voice signals according to a passage of time in obtaining the plurality of voice signals, to obtain a second time point, which precedes an utterance time corresponding to the designated call word from a first time point at which the designated call word is identified completely, and to perform speech recognition on one portion, which is obtained from the second time point, from among the plurality of voice signals.

### CROSS-REFERENCE TO RELATED APPLICATIONS

This application claims the benefit of Korean Patent Application No. 10-2024-0029183, filed on Feb. 28, 2024, which application is hereby incorporated herein by reference.

### TECHNICAL FIELD

The present disclosure relates to a speech recognition electronic device and a method thereof.

### BACKGROUND

A speech recognition service may refer to a service based on a technology for converting a voice signal into text or commands that are capable of being processed by an electronic device. A technology that allows the electronic device to process the content uttered by a user's voice and to convert the content into text or to perform a specific task by recognizing a voice command may be mainly used for the speech recognition service. Sound source localization or beamforming technology for tracking the user's location may be required for the electronic device to provide the speech recognition service. However, if the user utters while moving, speech recognition performance may rapidly deteriorate due to the fixed beamforming direction. Accordingly, there is a need to study a method of changing the location and/or direction of the electronic device depending on the user's location.

### SUMMARY

The present disclosure relates to an electronic device and a method thereof, and more particularly, relate to a technology for identifying a voice signal.

Some embodiments of the present disclosure can solve the above-mentioned problems occurring in the prior art while advantages achieved by the prior art are maintained intact.

An embodiment of the present disclosure can provide an electronic device for identifying a call word by using at least one microphone among a plurality of microphones, and a method thereof.

An embodiment of the present disclosure can provide an electronic device for performing speech recognition by using all of the plurality of microphones if a call word is identified, and a method thereof.

An embodiment of the present disclosure can provide an electronic device for changing a location of the electronic device based on a location where the call word occurs, if the call word is identified, and a method thereof.

Technical problems to be solved by an embodiment of the present disclosure are not limited to the aforementioned problems, and other technical problems not mentioned herein can be solved with an embodiment of the present disclosure, as can be understood from the following description by those skilled in the art to which the present disclosure pertains.

According to an embodiment of the present disclosure, an electronic device may include a plurality of microphones, a speaker, a processor, and a memory. The processor may be configured to obtain a plurality of voice signals by using the plurality of microphones, to identify a designated call word, by performing speech recognition on a first voice signal, which is obtained from a first microphone, from among the plurality of voice signals according to a passage of time in obtaining the plurality of voice signals, to obtain a second time point, which precedes an utterance time corresponding to the designated call word from a first time point at which the designated call word is identified completely, and to perform speech recognition on one portion, which is obtained from the second time point, from among the plurality of voice signals.

In an embodiment, the processor may be configured to track a location of a user associated with the plurality of voice signals by using a phase difference between the plurality of voice signals based on performing the speech recognition on the one portion, and to identify a second voice signal, which is obtained by enhancing a target voice corresponding to an utterance of the user, from the plurality of voice signals obtained by performing beamforming toward the location of the user by using the plurality of microphones.

In an embodiment, the processor may be configured to identify a noise signal included in the second voice signal based on identifying the second voice signal, and to reduce amplitude of the noise signal.

In an embodiment, the processor may be configured to identify a target voice signal indicating the target voice based on identifying the second voice signal, increase amplitude of the target voice signal included in the second voice signal, and to perform speech recognition by using the second voice signal with the increased amplitude of the target voice signal.

In an embodiment, the processor may be configured to reduce amplitude of a reference signal in each of the plurality of voice signals including the reference signal output from the speaker, and to track the location of the user by using a phase difference between the plurality of voice signals with the reduced amplitude of the reference signal.

In an embodiment, the processor may be configured to identify a reference signal indicating designated text, and a noise signal distinguished from the reference signal within the first voice signal, to reduce amplitude of at least one of the reference signal, or the noise signal, or any combination thereof, and to identify the designated call word by using the first voice signal with the reduced at least one amplitude.

In an embodiment, the processor may be configured to bypass speech recognition on other voice signals distinguished from the first voice signal among the plurality of voice signals while performing speech recognition on the first voice signal obtained from the first microphone.

In an embodiment, the processor may be configured to perform speech recognition on the first voice signal by using a first data set corresponding to the first voice signal, and to temporarily stop deletion of other data sets corresponding to the other voice signals based on a designated data size while bypassing speech recognition on the other voice signals.

In an embodiment, the processor may be configured to identify text data corresponding to the designated call word from the first data set, to obtain the second time point by performing rollback on the first data set and rollback on the other data sets based on the identified text data, and to perform speech recognition by using the first data set and all of the other data sets from the second time point.

In an embodiment, the processor may be configured to identify the first microphone among the plurality of microphones based on a distance from a user associated with the plurality of voice signals, and to obtain the first voice signal by using the first microphone.

According to an embodiment of the present disclosure, a method of an electronic device may include obtaining a plurality of voice signals by using a plurality of microphones, identifying a designated call word, by performing speech recognition on a first voice signal, which is obtained from a first microphone, from among the plurality of voice signals according to a passage of time in obtaining the plurality of voice signals, obtaining a second time point, which precedes an utterance time corresponding to the designated call word from a first time point at which the designated call word is identified completely, and performing speech recognition on one portion, which is obtained from the second time point, from among the plurality of voice signals.

In an embodiment, the performing of the speech recognition on the one portion may further include tracking a location of a user associated with the plurality of voice signals by using a phase difference between the plurality of voice signals based on performing the speech recognition on the one portion, and identifying a second voice signal, which is obtained by enhancing a target voice corresponding to an utterance of the user, from the plurality of voice signals obtained by performing beamforming toward the location of the user by using the plurality of microphones.

In an embodiment, the identifying of the second voice signal may include identifying a noise signal included in the second voice signal, and reducing amplitude of the noise signal.

In an embodiment, the identifying of the second voice signal may include identifying a target voice signal indicating the target voice, increasing amplitude of the target voice signal included in the second voice signal, and performing speech recognition by using the second voice signal with the increased amplitude of the target voice signal.

In an embodiment, the tracking of the location of the user may include reducing amplitude of a reference signal in each of the plurality of voice signals including the reference signal output from a speaker, and tracking the location of the user by using a phase difference between the plurality of voice signals with the reduced amplitude of the reference signal.

In an embodiment, the identifying of the designated call word may include identifying a reference signal indicating designated text, and a noise signal distinguished from the reference signal within the first voice signal, reducing amplitude of at least one of the reference signal, or the noise signal, or any combination thereof, and identifying the designated call word by using the first voice signal with the reduced at least one amplitude.

In an embodiment, the method may further include bypassing speech recognition on other voice signals distinguished from the first voice signal among the plurality of voice signals while performing speech recognition on the first voice signal obtained from the first microphone.

In an embodiment, the bypassing of the speech recognition on the other voice signals may include performing speech recognition on the first voice signal by using a first data set corresponding to the first voice signal, and temporarily stopping deletion of other data sets corresponding to the other voice signals based on a designated data size while bypassing the speech recognition on the other voice signals.

In an embodiment, the method may further include identifying text data corresponding to the designated call word from the first data set, obtaining the second time point by performing rollback on the first data set and rollback on the other data sets based on the identified text data, and performing speech recognition by using the first data set and all of the other data sets from the second time point.

In an embodiment, the method may further include identifying the first microphone among the plurality of microphones based on a distance from a user associated with the plurality of voice signals, and obtaining the first voice signal by using the first microphone.

### BRIEF DESCRIPTION OF THE DRAWINGS

The above and other features and advantages of the present disclosure can be more apparent from the following detailed description taken in conjunction with the accompanying drawings, in which:

FIG. 1 shows an example of a block diagram associated with an electronic device, according to an embodiment of the present disclosure;

FIG. 2 shows an example for describing an operation in which an electronic device performs speech recognition, according to an embodiment of the present disclosure;

FIG. 3 shows an example of a call word preprocessor included in an electronic device, according to an embodiment of the present disclosure;

FIG. 4 shows an example of a call word recognizer included in an electronic device, according to an embodiment of the present disclosure;

FIG. 5 shows an example for describing an operation, in which an electronic device identifies a continuous word, according to an embodiment of the present disclosure;

FIG. 6 shows an example of a continuous word preprocessor included in an electronic device, according to an embodiment of the present disclosure;

FIG. 7 shows an example of a flowchart for describing an operation of an electronic device, according to an embodiment of the present disclosure;

FIGS. 8A and 8B show an example for describing an operation, in which an electronic device receives a voice signal from a user, according to an embodiment of the present disclosure; and

FIG. 9 shows an example of a flowchart for describing a method performed by an electronic device, according to an embodiment of the present disclosure.

### DETAILED DESCRIPTION OF ILLUSTRATIVE EMBODIMENTS

Hereinafter, some embodiments of the present disclosure will be described in detail with reference to the accompanying drawings. In adding reference numerals to components of each drawing, it can be noted that the same components include the same reference numerals, although they are indicated on another drawing. Furthermore, in the present disclosure, detailed descriptions associated with well-known functions or configurations can be omitted if they may make subject matters of the present disclosure unnecessarily obscure.

In describing elements of an embodiment of the present disclosure, the terms “first”, “second”, “A”, “B”, “(a)”, “(b)”, and the like, may be used herein. These terms can be used merely to distinguish one element from another element, but do not necessarily limit the corresponding elements irrespective of the nature, order, or priority of the corresponding elements. Furthermore, unless otherwise defined, terms including technical and scientific terms used herein can be interpreted as is customary in the art to which the present disclosure belongs. It can be understood that terms used herein can be interpreted as including a meaning that is consistent with their meaning in the context of the present disclosure and the relevant art.

In various embodiments of the present disclosure, the term “module” used herein may include a unit, which is implemented with hardware, software, or firmware, and may be interchangeably used with the terms “logic”, “logical block”, “part”, or “circuit”. The “module” may be a minimum unit of an integrated part or may be a minimum unit of the part for performing one or more functions or a part thereof. For example, according to an embodiment, the module may be implemented in the form of an application-specific integrated circuit (ASIC). According to various embodiments, operations executed by modules, programs, or other components may be executed by a successive method, a parallel method, or a repeated method. Alternatively, at least one or more of the operations may be executed in another order or may be omitted, or one or more operations may be added.

Various embodiments of the present disclosure may be implemented with software (e.g., a program) including one or more instructions stored in a storage medium (e.g., an internal memory or an external memory) readable by a machine (e.g., an electronic device 100). For example, the processor (e.g., the processor 110) of the machine (e.g., the electronic device 100) may call at least one instruction of the stored one or more instructions from a storage medium and then may execute the at least one instruction. This enables the machine to operate to perform at least one function depending on the called at least one instruction. The one or more instructions may include a code generated by a complier or a code executable by an interpreter. The machine-readable storage medium may be provided in the form of a non-transitory storage medium. Herein, ‘non-transitory’ can be a storage medium that is a tangible device and may not include a signal (e.g., electromagnetic waves), and this term does not necessarily distinguish between a case where data is semi-permanently stored in the storage medium and a case where the data is stored temporarily.

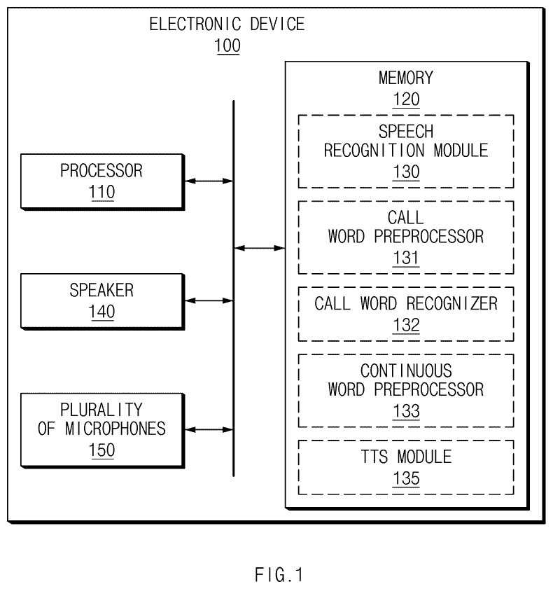

Hereinafter, various embodiments of the present disclosure will be described in detail with reference to FIGS. 1 to 9.

FIG. 1 shows an example of a block diagram associated with an electronic device, according to an embodiment of the present disclosure.

An electronic device 100 according to an embodiment may include at least one of a processor 110, a memory 120, a speaker 140, or a plurality of microphones 150, any combination of or all of which may be in plural or may include plural components thereof. The processor 110, the memory 120, the speaker 140, and the plurality of microphones 150 may be electrically and/or operably coupled with each other by an electronic component including a communication bus. Hereinafter, pieces of hardware can be coupled operably so that a direct or indirect connection between the pieces of hardware can be established by wired or wirelessly such that second hardware can be controlled by first hardware among the pieces of hardware. Although shown based on different blocks, an embodiment is not limited thereto. For example, some (e.g., at least part of the processor 110, the memory 120, and a communication circuit (not shown)) of pieces of hardware in FIG. 1 may be included in a single integrated circuit, such as a system on a chip (SoC). The electronic device 100 may further include components not illustrated in FIG. 1.

The processor 110 of the electronic device 100 according to an embodiment may include a hardware component for processing data based on one or more instructions. The hardware component for processing data may include, for example, an arithmetic and logic unit (ALU), a floating point unit (FPU), a field programmable gate array (FPGA), a central processing unit (CPU), a micro controller unit (MCU), an application processor (AP), or any combination thereof. The number of processors 110 may be one or more, together and/or separated. For example, the processor 110 may include a structure of a multi-core processor including a dual core, a quad core, a hexa core, or an octa core.

The memory 120 of the electronic device 100 according to an embodiment may include a hardware component for storing data and/or instructions that are to be input and/or output to the processor 110. For example, the memory 120 may include a volatile memory such as a random-access memory (RAM), and/or a non-volatile memory such as a read-only memory (ROM). For example, the volatile memory may include at least one of a dynamic RAM (DRAM), a static RAM (SRAM), a cache RAM, or a pseudo SRAM (PSRAM). For example, the non-volatile memory includes at least one of a programmable ROM (PROM), an erasable PROM (EPROM), an electrically erasable PROM (EEPROM), a flash memory, a hard disk, a compact disk, or an embedded multi-media card (eMMC). For example, hereinafter, configurations (e.g., a speech recognition module 130, a call word preprocessor 131, a call word recognizer 132, a continuous word preprocessor 133, and/or a text to speech (TTS) module 135) included within the memory 120 may be logically separated from each other.

The speaker 140 of the electronic device 100 according to an embodiment may output an audio signal. For example, the electronic device 100 may obtain an electrical signal. For example, the electronic device 100 may convert the electrical signal into a sound wave signal by using the speaker 140. For example, the electronic device 100 may output an audio signal including the converted sound wave signal by using the speaker 140.

The plurality of microphones 150 of the electronic device 100 according to an embodiment may receive an audio (or voice) signal from outside of the electronic device 100. For example, the plurality of microphones 150 may be placed in a portion of the housing of the electronic device 100, together and/or separated. For example, at least one of the plurality of microphones 150 may be referred to as a feed-forward microphone in that it is placed toward the outside of the electronic device 100. A plurality of voice signals obtained by the electronic device 100 by using the plurality of microphones 150 may be divided in units of channel.

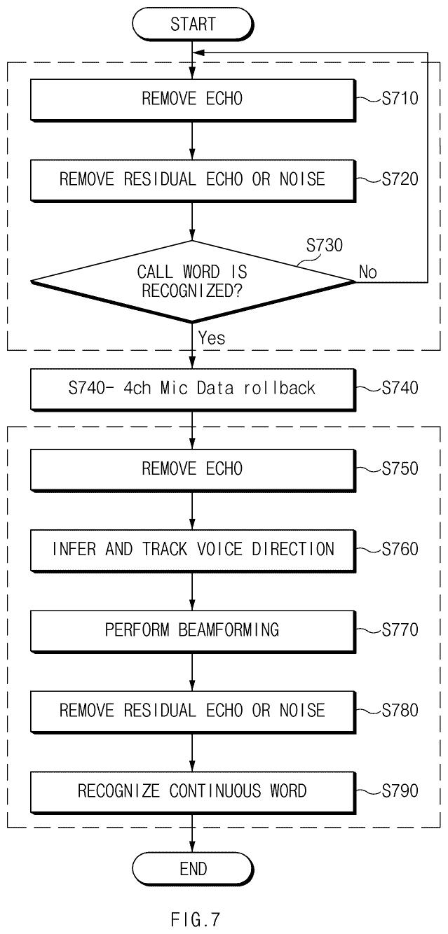

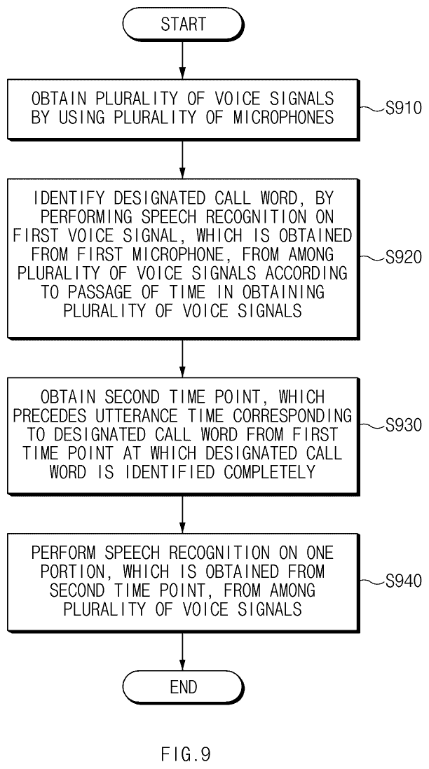

One or more instructions (or instructions) indicating an arithmetic operation and/or an operation to be performed on data by the processor 110 may be stored in the memory 120 of the electronic device 100. A set of one or more instructions may be referred to as a “firmware”, an “operating system”, a “process”, a “routine”, a “sub-routine”, and/or an “application”. For example, if a set of a plurality of instructions distributed in a form of an operating system, firmware, drivers, and/or applications are executed, the electronic device 100 and/or the processor 110 may perform at least one of the operations of FIGS. 7 and 9.

The electronic device 100 according to an embodiment may perform an operation (or a function) corresponding to a plurality of voice signals, which can be obtained through the plurality of microphones 150, by using the speech recognition module 130. An operation corresponding to a plurality of voice signals may include a function (or a service) performed by the electronic device 100 in response to a user utterance.

For example, if identifying a designated call word (or a call command) by using the speech recognition module 130 (or after identifying the designated call word), the electronic device 100 may activate (or execute) a speech recognition service (or a speech recognition function). The speech recognition module 130 may be used to receive (or input) a plurality of voice signals together with a designated call word or after the designated call word is detected, and to recognize the received voice (e.g., automatic speech recognition (ASR)). For example, the electronic device 100 may perform language processing (e.g., natural language understanding (NLU)), and/or dialogue management (DM)) on a voice signal by using the speech recognition module 130.

For example, the designated call word may include text information (or voice information) that allows the electronic device 100 to initiate the execution of the speech recognition function.

The electronic device 100 according to an embodiment may obtain a reference signal to be output from the speaker 140 by using the text-to-speech (TTS) module 135. The reference signal may include an audio signal for guiding users by using the speech recognition service. The reference signal may be generated by using data obtained from the memory 120 or an external server. The electronic device 100 may output the generated reference signal through the speaker 140. If the reference signal output from the speaker 140 is obtained through the plurality of microphones 150, the reference signal may be referred to as an echo (or noise). The TTS module 135 may be used to perform a TTS function (or service).

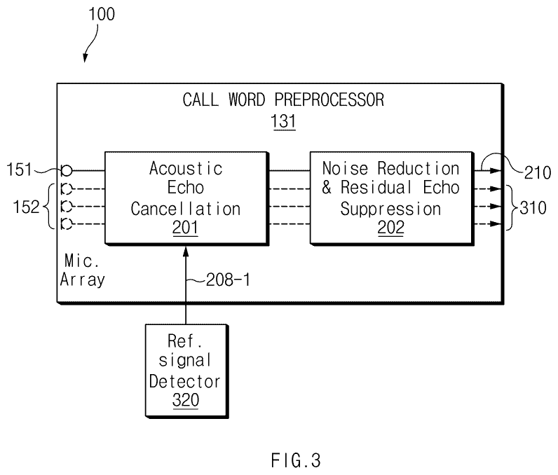

The electronic device 100 according to an embodiment may change a first voice signal among a plurality of voice signals, which are obtained through the plurality of microphones 150, by using the call word preprocessor 131. For example, the electronic device 100 may remove a noise signal from the first voice signal. The electronic device 100 may remove the reference signal from the first voice signal. An operation in which the electronic device 100 changes the first voice signal by using the call word preprocessor 131 will be described in more detail later with reference to FIG. 3.

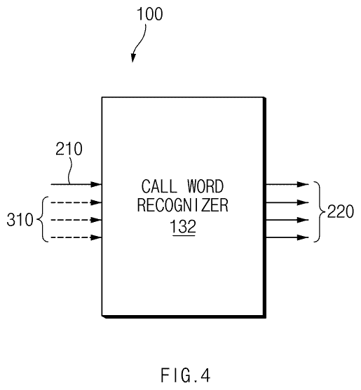

The electronic device 100 according to an embodiment may identify a designated call word from the first voice signal, which can be changed through the call word preprocessor 131, by using the call word recognizer 132. The call word recognizer 132 may be used to perform a keyword spotting (KWS) function (or service) for identifying a designated call word (or keyword). The call word recognizer 132 may include a model set (or trained) to identify a call word defined (or set) in advance. An operation in which the electronic device 100 recognizes a designated call word by using the call word recognizer 132 will be described in more detail later with reference to FIG. 4.

The electronic device 100 according to an embodiment may tune (or change) data sets corresponding to a plurality of voice signals to be identified through the speech recognition module 130 by using the continuous word preprocessor 133. The plurality of voice signals may correspond to a call word and/or continuous word uttered by a user. For example, the continuous word may represent the user's command uttered (or is obtained) in succession to the call word. For example, the electronic device 100 may perform a function corresponding to a continuous word by identifying the continuous word.

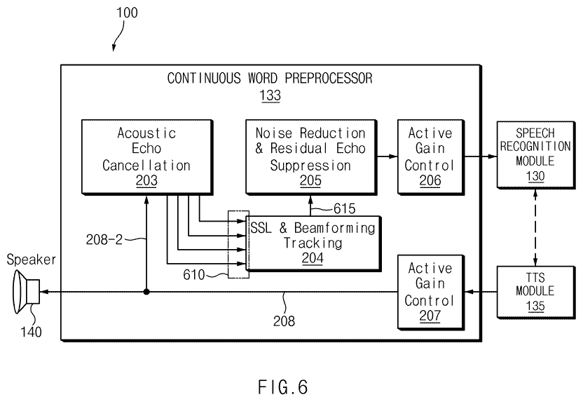

For example, the electronic device 100 may enhance a target voice corresponding to the user's voice in a plurality of voice signals by using the continuous word preprocessor 133. For example, the electronic device 100 may cancel noise included in the plurality of voice signals by using the continuous word preprocessor 133. However, an embodiment is not limited thereto. An operation in which the electronic device 100 tunes a plurality of voice signals by using the continuous word preprocessor 133 will be described in more detail later with reference to FIG. 6.

The electronic device 100 according to an embodiment may obtain the plurality of voice signals by using the plurality of microphones 150.

In an embodiment, the electronic device 100 may perform speech recognition on a first voice signal, which is obtained from a first microphone, from among the plurality of voice signals according to the passage of time in obtaining the plurality of voice signals.

For example, the electronic device 100 may identify the first microphone among the plurality of microphones 150 based on a distance from a user associated with the plurality of voice signals. The electronic device 100 may identify the first voice signal obtained by using the first microphone. However, an embodiment is not limited thereto. For example, the electronic device 100 may set the first microphone for obtaining the first voice signal for identifying the designated call word among the plurality of voice signals.

For example, the electronic device 100 may identify the designated call word by performing speech recognition on the first voice signal.

The electronic device 100 according to an embodiment may identify a first time point, at which the designated call word is completely identified, according to the passage of time in obtaining the plurality of voice signals.

For example, the electronic device 100 may identify an utterance time corresponding to the designated call word. The utterance time corresponding to the designated call word may vary depending on the length of the designated call word. For example, the electronic device 100 may set the utterance time corresponding to the designated call word.

The electronic device 100 according to an embodiment may obtain a second time point, which precedes the utterance time corresponding to the designated call word from the first time point at which the designated call word is identified completely.

For example, the electronic device 100 may obtain a plurality of data sets corresponding to the plurality of voice signals, respectively. The electronic device 100 may perform speech recognition on the first voice signal by using a first data set corresponding to the first voice signal among the plurality of voice signals.

For example, the electronic device 100 may identify text data corresponding to the designated call word from the first data set.

For example, the electronic device 100 may perform rollback on the first data set based on text data. For example, the electronic device 100 may perform rollback on other data sets distinguished from the first data set based on the text data. For example, the electronic device 100 may obtain the second time point by performing rollback on all of the plurality of data sets.

The electronic device 100 according to an embodiment may perform speech recognition on all of the plurality of voice signals from the second time point. For example, the electronic device 100 may perform speech recognition on the plurality of data sets rolled back based on the text data.

For example, the electronic device 100 may generate a reference signal to be output from the TTS module 135 based on performing speech recognition on all of the plurality of voice signals from the second time point.

For example, the reference signal may include information indicating the answer to the user's query corresponding to the plurality of voice signals. However, an embodiment is not limited thereto.

As described above, the electronic device 100 according to an embodiment may obtain a plurality of voice signals from the plurality of microphones 150. For example, the electronic device 100 may identify a designated call word by using the first voice signal among the plurality of voice signals by using a smaller computation volume than if identifying the designated call word by using all of the plurality of voice signals. For example, the electronic device 100 may perform rollback on a plurality of data sets corresponding to the plurality of voice signals based on identifying the designated call word. For example, the electronic device 100 may process the plurality of data sets corresponding to a time point before the designated call word is identified, by performing rollback on the plurality of data sets. The electronic device 100 may process the plurality of data sets rolled back, thereby improving the accuracy of speech recognition.

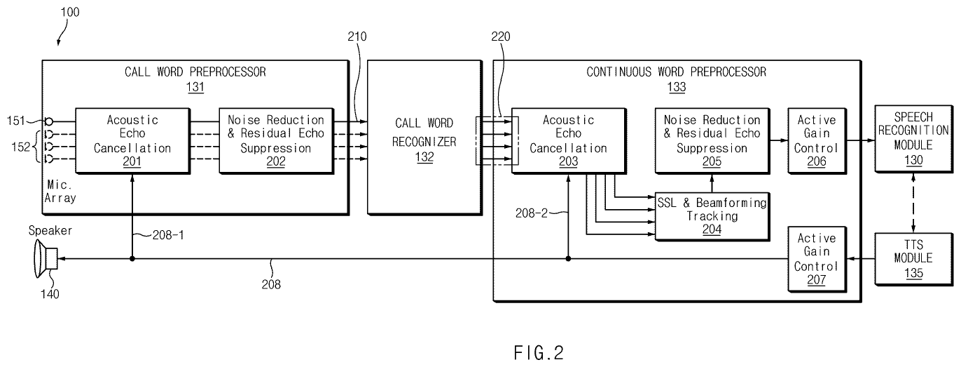

FIG. 2 shows an example for describing an operation in which an electronic device performs speech recognition, according to an embodiment of the present disclosure. Referring to FIG. 2, the electronic device 100 may refer to the electronic device 100 of FIG. 1. Referring to FIG. 2, one or more filters for processing (or changing) a plurality of voice signals may be included within the call word preprocessor 131, the call word recognizer 132, and/or the continuous word preprocessor 133.

The electronic device 100 according to an embodiment may obtain the plurality of voice signals by using a plurality of microphones (e.g., the plurality of microphones 150 in FIG. 1). For example, a first microphone 151 and/or other microphones 152 may be included in the plurality of microphones 150 in FIG. 1. For example, the electronic device 100 may tune (or change) a first voice signal 210, which can be obtained by using the first microphone 151 among the plurality of microphones 150, through the call word preprocessor 131.

The electronic device 100 according to an embodiment may perform acoustic echo cancellation (AEC) 201 on the first voice signal 210. The acoustic echo cancellation 201 may be used to remove acoustic feedback between the speaker 140 and the plurality of microphones 150.

For example, if a reference signal 208 capable of being output from the speaker 140 is included in the first voice signal 210, the electronic device 100 may reduce (or remove) the amplitude of a portion corresponding to the reference signal 208 in the first voice signal 210 by performing the acoustic echo cancellation 201 on the first voice signal 210.

For example, the reference signal 208 may be obtained by using at least one piece of data included in a memory (e.g., the memory 120 in FIG. 1).

For example, if the reference signal 208 output from the speaker 140 is included in a plurality of voice signals obtained by using the plurality of microphones 150, the reference signal 208 may be referred to as an “echo signal 208-1”. The electronic device 100 may reduce the echo, which is included in a voice signal for performing speech recognition, by performing the acoustic echo cancellation 201.

The electronic device 100 according to an embodiment may perform noise reduction and residual echo suppression 202 on the first voice signal 210. The electronic device 100 may remove (or reduce) noise and/or residual echo included in the first voice signal 210 by performing the noise reduction and residual echo suppression 202. The residual echo may be identified based on noise, time, and/or frequency. For example, the noise may be distinguished from the reference signal 208 and may include sound information generated from outside the electronic device 100.

The electronic device 100 according to an embodiment may identify a designated call word through the first voice signal 210 by using the call word recognizer 132. For example, before identifying the designated call word by using the call word recognizer 132, the electronic device 100 may identify the designated call word by performing speech recognition on the first voice signal 210 obtained by using the first microphone 151 among the plurality of microphones 150. For example, until identifying the designated call word by using the call word recognizer 132, the electronic device 100 may bypass speech recognition on other voice signals obtained by using the other microphones 152 among the plurality of microphones 150.

For example, while the electronic device 100 performs speech recognition on the first voice signal 210 before identifying the designated call word, the electronic device 100 may bypass speech recognition on other voice signals distinguished from the first voice signal 210 among a plurality of voice signals.

For example, while bypassing speech recognition for the other voice signals, the electronic device 100 may temporarily store data sets corresponding to the other voice signals in a memory.

For example, the electronic device 100 may initiate the speech recognition by using all of a plurality of voice signals 220 based on identifying the designated call word by using the call word recognizer 132.

For example, the electronic device 100 may perform rollback on data sets corresponding to the plurality of voice signals 220 based on a designated time point by identifying the designated call word. The designated time point may include a time before a time corresponding to the designated call word from a time point at which the designated call word is completely identified. For example, the electronic device 100 may perform speech recognition on all of the plurality of voice signals 220 from the designated time point.

The electronic device 100 according to an embodiment may perform acoustic echo cancellation 203 on all of the plurality of voice signals 220 by using the continuous word preprocessor 133. The acoustic echo cancellation 203 may refer to the acoustic echo cancellation 201. For example, the acoustic echo cancellation 201 may be used to process a data set corresponding to a single channel (or one voice signal). The acoustic echo cancellation 203 may be used to process data sets corresponding to multi-channels (or a plurality of voice signals). An echo signal 208-2 may refer to the echo signal 208-1.

The electronic device 100 according to an embodiment may perform sound source localization (SSL) and beamforming tracking 204 by using the plurality of voice signals 220 from which an echo is removed. For example, the electronic device 100 may perform beamforming by tracking a user's location related to the plurality of voice signals 220. For example, the electronic device 100 may identify sources (e.g., the user's location) of the plurality of voice signals 220 by using a direction in which each of the plurality of microphones 150 is facing and/or a location at which each of the plurality of microphones 150 is placed. For example, the electronic device 100 may obtain the sources of the plurality of voice signals 220 by using a filter (e.g., Kalman/particle filter) for identifying the sources. For example, the electronic device 100 may obtain a plurality of voice signals in which the target voice uttered from the user is enhanced, based on performing beamforming by identifying the sources of the plurality of voice signals 220.

For example, the electronic device 100 may synchronize the plurality of voice signals 220 with each other based on a phase difference between the plurality of voice signals 220, and/or a time difference from obtaining the plurality of voice signals 220. For example, the electronic device 100 may perform noise reduction and residual echo suppression 205 by using a plurality of synchronized voice signals 230. For example, the noise reduction and residual echo suppression 205 may refer to the noise reduction and residual echo suppression 202.

For example, the electronic device 100 may process data sets corresponding to the plurality of voice signals 220 with enhanced target voices by using the speech recognition module 130, by using active gain control 206 for enhancing the amplitude (or gain) of an area corresponding to the target voice included in the plurality of voice signals 220.

For example, the electronic device 100 may obtain the reference signal 208, which indicates an answer corresponding to speech recognition, by using the TTS module 135 based on processing data sets by using the speech recognition module 130. The electronic device 100 may change at least one area of the reference signal 208 by performing active gain control 207 for enhancing the amplitude (or gain) of the at least one area of the reference signal 208 obtained by using the TTS module 135. The changed reference signal 208 may be output through the speaker 140. However, an embodiment is not limited thereto.

As described above, the electronic device 100 according to an embodiment may reduce the computation volume for processing data compared to a case of identifying a designated call word based on multi-channels, by identifying a designated call word based on one (a) channel. The electronic device 100 may track the location of a user who uttered the designated call word, based on identifying the designated call word. The electronic device 100 may obtain a voice signal with an enhanced target voice uttered from the user, by performing beamforming toward the user's location. The electronic device 100 may perform speech recognition on the target voice accurately by obtaining a voice signal with the enhanced target voice.

FIG. 3 shows an example of a call word preprocessor included in an electronic device, according to an embodiment of the present disclosure. The electronic device 100 of FIG. 3 may refer to the electronic device 100 of FIG. 1.

Referring to FIG. 3, the electronic device 100 according to an embodiment may obtain a plurality of voice signals 210 and 310 by using the plurality of microphones 151 and 152.

For example, the electronic device 100 may select the first microphone 151 for recognizing the designated call word among the plurality of microphones 151 and 152.

For example, the electronic device 100 may perform speech recognition on the first voice signal 210 obtained from the first microphone 151. The electronic device 100 may perform call word preprocessing by using the first voice signal 210.

While performing speech recognition on the first voice signal 210 obtained from the first microphone 151, the electronic device 100 according to an embodiment may bypass speech recognition on other voice signals 310 distinguished from the first voice signal 210 among the plurality of voice signals 210 and 310. The other voice signals 310 may be obtained through the other microphones 152.

The electronic device 100 according to an embodiment may perform speech recognition on the first voice signal by using the first data set corresponding to the first voice signal 210.

While bypassing speech recognition on the other voice signals 310, the electronic device 100 according to an embodiment may temporarily stop deletion of other data sets corresponding to the other voice signals 310 based on a designated data size (or length). The electronic device 100 may temporarily store the other data sets. If identifying the designated call word, the electronic device 100 may temporarily stop the deletion of the other data sets, at least temporarily, to use the other data sets.

The electronic device 100 according to an embodiment may identify a reference signal (e.g., the reference signal 208 in FIG. 2) indicating designated text, and a noise signal distinguished from the reference signal within the first voice signal 210. For example, if the reference signal is identified through a microphone, the reference signal may be referred to as the echo signal 208-1.

For example, the reference signal may be obtained based on a TTS module (e.g., the TTS module 135 in FIG. 1).

The electronic device 100 according to an embodiment may reduce the amplitude of at least one of the reference signal (e.g., the echo signal 208-1), or the noise signal, or any combination thereof.

For example, the electronic device 100 may determine whether the reference signal (e.g., the echo signal 208-1) output from a speaker is included in the first voice signal 210 by using the reference (Ref.) signal detector 320.

For example, if the reference signal is included in the first voice signal 210, the electronic device 100 may perform the acoustic echo cancellation 201 on the reference signal.

For example, if identifying a reference signal (e.g., the echo signal 208-1) with amplitude greater than threshold amplitude by using the Ref. signal detector 320, the electronic device 100 may change the first voice signal 210 by applying the acoustic echo cancellation 201 to the reference signal.

The electronic device 100 according to an embodiment may remove noise or may reduce a residual echo by applying the noise reduction and residual echo suppression 202 to the first voice signal 210 based on identifying the noise signal.

The electronic device 100 according to an embodiment may identify a designated call word by using a first voice signal with the reduced amplitude of at least one of the noise signal or the echo signal. For example, an operation, in which the electronic device 100 identifies a designated call word based on the execution of a call word recognizer by using the first voice signal, will be described later with reference to FIG. 4.

As described above, the electronic device 100 according to an embodiment may reduce the computation volume for recognizing a call word, by performing call word preprocessing on one voice signal (e.g., the first voice signal 210) among the plurality of voice signals 210 and 310. Because the electronic device 100 initiates execution of the acoustic echo cancellation 201 for removing an echo within one voice signal, depending on whether it identifies the echo signal 208-1, the electronic device 100 may reduce the computation volume (or computation time) for performing call word preprocessing.

FIG. 4 shows an example of a call word recognizer included in an electronic device, according to an embodiment of the present disclosure. The electronic device 100 of FIG. 4 may refer to the electronic device 100 of FIG. 1.

While performing speech recognition on the first voice signal 210, the electronic device 100 according to an embodiment may bypass speech recognition on the other voice signals 310. The electronic device 100 may identify a designated call word by using the call word recognizer 132 by performing speech recognition on the first voice signal 210.

For example, the electronic device 100 may identify text data corresponding to the designated call word by performing keyword spotting (KWS) on a data set (or text stream) corresponding to the first voice signal 210 by using the call word recognizer 132.

For example, while bypassing speech recognition on the other voice signals 310, the electronic device 100 may temporarily maintain storage of data sets corresponding to the other voice signals 310. The electronic device 100 may perform buffering on the data sets corresponding to the other voice signals 310.

For example, the electronic device 100 may initiate speech recognition on all of the plurality of voice signals 220 based on identifying the designated call word. After performing rollback on all of the plurality of data sets corresponding to the plurality of voice signals 220, the electronic device 100 may perform speech recognition by using a plurality of data sets rolled back. The plurality of voice signals 220 may include the first voice signal 210 and/or the other voice signals 310.

For example, the electronic device 100 may identify a second time point, which precedes the utterance time corresponding to the designated call word from the first time point at which the designated call word is identified completely. The electronic device 100 may roll back a plurality of data sets corresponding to the plurality of voice signals 220 based on the information (or version) corresponding to the second time point.

As described above, after recognizing the designated call word, the electronic device 100 according to an embodiment may perform speech recognition by using a plurality of voice signals corresponding to multi-channels, thereby improving the accuracy of speech recognition.

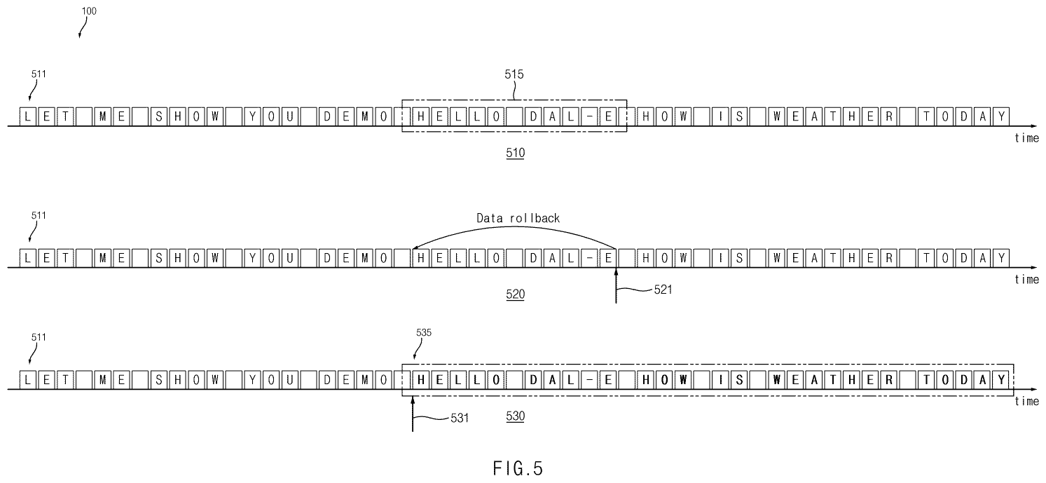

FIG. 5 shows an example for describing an operation, in which an electronic device identifies a continuous word, according to an embodiment of the present disclosure. The electronic device 100 of FIG. 5 may refer to the electronic device 100 of FIG. 1.

In a state 510, the electronic device 100 according to an embodiment may obtain a plurality of voice signals by using a plurality of microphones.

For example, the electronic device 100 may identify a designated call word 515 by using a first voice signal among the plurality of voice signals.

For example, the electronic device 100 may identify the designated call word 515, by performing speech recognition on the first voice signal among the plurality of voice signals according to the passage of time in obtaining the plurality of voice signals.

For example, the electronic device 100 may obtain a plurality of data sets 511 (or text stream) corresponding to the plurality of voice signals according to the passage of time in obtaining the plurality of voice signals. For example, because the plurality of voice signals are synchronized with each other, each of the plurality of data sets 511 may be mapped to include substantially the same information at one time point.

For example, the electronic device 100 may identify the designated call word 515 (e.g., Hello DAL-e in FIG. 5) by using a first data set corresponding to the first voice signal among the plurality of data sets 511.

The electronic device 100 according to an embodiment may identify text data corresponding to the designated call word 515 from the first data set.

In a state 520, the electronic device 100 according to an embodiment may identify a first time point 521 at which the designated call word 515 is completely identified.

For example, the electronic device 100 may identify an utterance time corresponding to the designated call word 515.

For example, the electronic device 100 may obtain a second time point 531, which precedes an utterance time corresponding to the designated call word 515 from the first time point 521.

The electronic device 100 according to an embodiment may perform rollback on the first data set and rollback on other data sets based on text data corresponding to the designated call word 515. The other data sets may correspond to other voice signals other than the first voice signal among the plurality of voice signals.

For example, until the first time point 521 at which the designated call word 515 is identified, the electronic device 100 may at least temporarily stop processing of at least one data set among the plurality of data sets 511. In other words, the processing (e.g., deletion) of the at least one data set may be pending. However, an embodiment is not limited thereto.

For example, after identifying the designated call word 515, the electronic device 100 may perform rollback on all of the plurality of data sets 511. As performing rollback on all of the plurality of data sets 511, the electronic device 100 may restore the plurality of data sets 511 to a version corresponding to a time point preceding the second time point 531. The electronic device 100 may perform speech recognition from the second time point 531 by using all of the restored plurality of data sets 511.

In a state 530, the electronic device 100 according to an embodiment may perform speech recognition by using the first data set and the other data sets from the second time point 531.

The electronic device 100 according to an embodiment may perform speech recognition on one portion 535 obtained from the second time point among the plurality of voice signals. For example, the electronic device 100 may perform speech recognition on the one portion 535, which is obtained after the second time point 531, by using the plurality of data sets 511 corresponding to the plurality of voice signals. The one portion 535 may include text data corresponding to the designated call word 515 and/or a continuous word (or a command) for calling at least one function (or task) capable of being performed by the electronic device 100.

For example, if the one portion 535 does not include a continuous word for calling at least one function, the electronic device 100 may enter the state 510 from the state 530. For example, if the one portion 535 does not include a continuous word for calling at least one function, the electronic device 100 may resume an operation of identifying the designated call word 515 by using at least one voice signal among the plurality of voice signals.

FIG. 6 shows an example of a continuous word preprocessor included in an electronic device, according to an embodiment of the present disclosure. The electronic device 100 of FIG. 6 may refer to the electronic device 100 of FIG. 1.

To perform speech recognition on all of a plurality of voice signals from a second time point (e.g., the second time point 531 in FIG. 5), the electronic device 100 according to an embodiment may perform a preprocessing operation by using a continuous word preprocessor 133.

For example, the electronic device 100 may remove an echo signal 208-2 included in the plurality of voice signals rolled back to the second time point. For example, the electronic device 100 may identify a plurality of voice signals 610, from which the echo signal 208-2 is removed, by applying the acoustic echo cancellation 203 to all of the plurality of voice signals rolled back.

For example, the echo signal 208-2 may be included in the reference signal 208 obtained based on the TTS module 135.

The electronic device 100 according to an embodiment may track a user's location associated with the plurality of voice signals 610 by using a phase difference between the plurality of voice signals 610 based on performing speech recognition on one portion (e.g., the one portion 535 in FIG. 5) of the plurality of voice signals. The electronic device 100 may track the user's location associated with the plurality of voice signals 610 by performing the sound source localization and beamforming tracking 204.

For example, the electronic device 100 may reduce the amplitude of the reference signal 208 (or the echo signal 208-2) in each of the plurality of voice signals 610 including the reference signal 208 output from the speaker 140. The electronic device 100 may track the user's location by using the phase difference between the plurality of voice signals 610 with the reduced amplitude of the reference signal.

For example, the electronic device 100 may identify a second voice signal 615, which can be obtained by enhancing a target voice corresponding to the user's utterance, from the plurality of voice signals by performing beamforming toward the user's location by using a plurality of microphones.

For example, the second voice signal 615 may be obtained based on the plurality of synchronized voice signals 610. For example, the second voice signal 615 may include at least one voice signal among the plurality of synchronized voice signals 610.

The electronic device 100 according to an embodiment may identify the noise signal included in the second voice signal 615 based on obtaining the second voice signal 615.

For example, the electronic device 100 may remove a noise signal by using the noise reduction and residual echo suppression 205. For example, the electronic device 100 may reduce the amplitude of the noise signal.

The electronic device 100 according to an embodiment may identify a target voice signal indicating the target voice corresponding to the user's utterance based on obtaining the second voice signal 615. For example, after removing the noise signal included in the second voice signal 615, the electronic device 100 may identify a target voice signal.

For example, the electronic device 100 may emphasize the target voice signal to improve the accuracy of speech recognition. For example, the electronic device 100 may increase the amplitude of the target voice signal included in the second voice signal 615.

For example, the electronic device 100 may perform speech recognition through the speech recognition module 130 by using a second voice signal with the increased amplitude of the target voice signal.

After performing speech recognition, the electronic device 100 according to an embodiment may generate the reference signal 208 for guiding the user to an answer to the result of speech recognition through the TTS module 135. After applying the active gain control 207 to at least one portion of the reference signal 208, the electronic device 100 may output the reference signal 208 by using the speaker 140.

As described above, after identifying a call word, the electronic device 100 according to an embodiment performs speech recognition on the plurality of voice signals obtained by using a plurality of microphones, thereby improving the accuracy of speech recognition for a continuous word uttered after a call word from a user.

FIG. 7 shows an example of a flowchart for describing an operation of an electronic device, according to an embodiment of the present disclosure.

Hereinafter, as an example case, it can be assumed that the electronic device 100 of FIG. 1 performs a process of FIG. 7. In addition, in a description of FIG. 7, it may be understood that an operation described as being performed by a device is controlled by the processor 110 of the electronic device 100, for example. Each of the operations in FIG. 7 may be performed sequentially, but is not necessarily sequentially performed. For example, the order of operations may be changed, and at least two operations may be performed in parallel.

Referring to FIG. 7, in operation S710, an electronic device according to an embodiment may remove an echo included in a first voice signal among a plurality of voice signals. The first voice signal may be obtained through a first microphone for identifying a designated call word among a plurality of microphones. The electronic device may obtain the plurality of voice signals over time by using the plurality of microphones and may remove the echo included in the first voice signal among the plurality of obtained voice signals.

Referring to FIG. 7, in operation S720, the electronic device according to an embodiment may remove a residual echo or noise included in the first voice signal from which the echo is removed. Operations S710 and S720 may be included in a preprocessing operation for identifying a call word.

Referring to FIG. 7, in operation S730, the electronic device according to an embodiment may determine whether the call word is recognized. For example, if the electronic device does not recognize the call word (operation S730=No), the electronic device may perform operation S710.

Referring to FIG. 7, if recognizing the call word by using the first voice signal (operation S730=Yes), in operation S740, the electronic device according to an embodiment may roll back microphone data (e.g., the plurality of data sets 511 in FIG. 5) based on multi-channels.

For example, the electronic device may roll back the microphone data from a time point, at which the call word is completely identified, to a time point before a time corresponding to the call word. The electronic device may perform speech recognition on the microphone data by using the first voice signal based on one channel from operation S710 to the time point at which the call word is completely identified.

For example, after identifying the call word, the electronic device may perform speech recognition by using the microphone data corresponding to a plurality of voice signals based on multi-channels. To perform operations S750 to S790, the electronic device may process all of the plurality of voice signals based on multi-channels.

Referring to FIG. 7, in operation S750, the electronic device according to an embodiment may remove an echo included in the plurality of voice signals.

Referring to FIG. 7, in operation S760, the electronic device according to an embodiment may infer and/or track a voice direction by using the plurality of voice signals from which the echo is removed. For example, the electronic device may infer or track the voice direction based on a phase difference between the plurality of voice signals. The voice direction may include a direction toward the user's location for performing speech recognition from the electronic device.

Referring to FIG. 7, in operation S770, the electronic device according to an embodiment may perform beamforming based on the voice direction. The electronic device may obtain the plurality of voice signals with the enhanced target voice uttered from the user to perform speech recognition, based on performing the beamforming.

Referring to FIG. 7, in operation S780, the electronic device according to an embodiment may remove the residual echo or noise included in the plurality of voice signals with the enhanced target voice.

Referring to FIG. 7, in operation S790, the electronic device according to an embodiment may recognize a continuous word by using the plurality of voice signals from which the residual echo or noise is removed. The continuous word may indicate a voice command uttered from the user after the call word is identified. The electronic device may perform a function corresponding to a continuous word based on recognizing the continuous word.

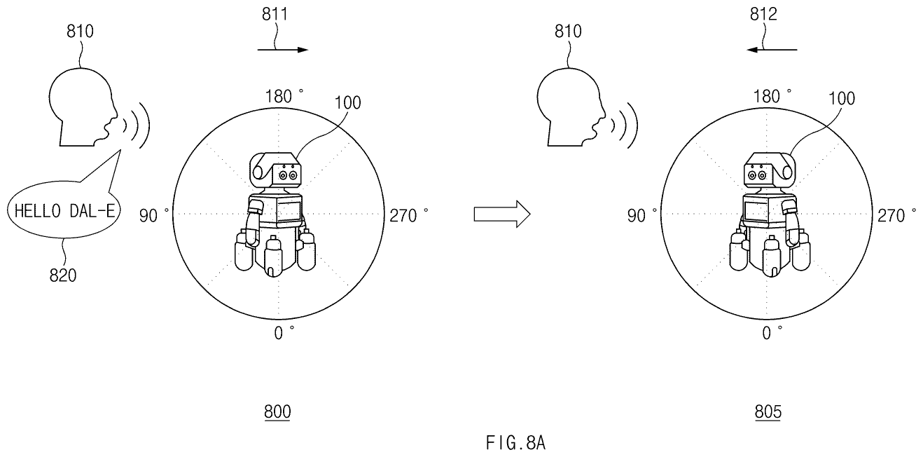

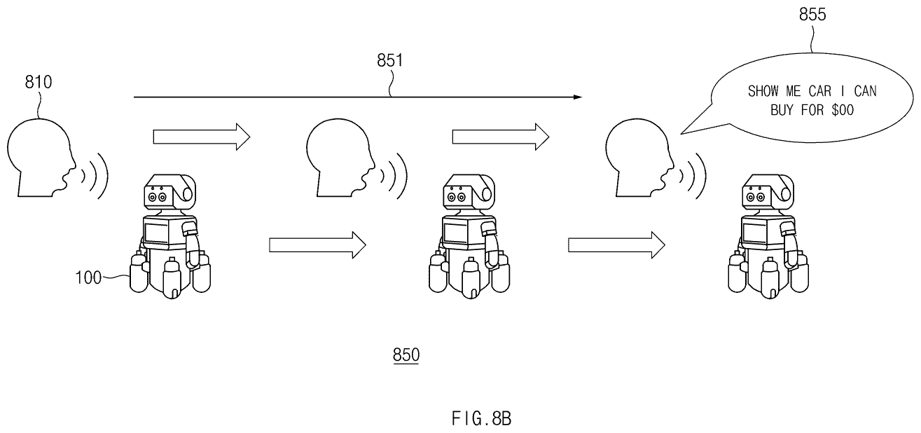

FIGS. 8A and 8B show an example for describing an operation, in which an electronic device receives a voice signal from a user, according to an embodiment of the present disclosure. The electronic device of FIGS. 8A and 8B may refer to the electronic device 100 of FIG. 1.

Referring to FIG. 8A, in a state 800, the electronic device 100 according to an embodiment may be placed such that one surface (e.g., a front surface) of the electronic device 100 faces a direction 811 in which a user 810 is looking.

For example, the electronic device 100 may obtain a plurality of voice signals indicating a designated call word 820 from the user 810 by using a plurality of microphones. The electronic device 100 may identify the designated call word 820 by using a first voice signal obtained by using a first microphone among the plurality of microphones.

For example, each of the plurality of microphones (e.g., the plurality of microphones 150 in FIG. 1) may be placed within the electronic device 100 in different directions, and thus the electronic device 100 may obtain a plurality of voice signals generated at a periphery of the electronic device 100.

For example, the electronic device 100 may track the location of the user 810 by using a phase difference between the plurality of voice signals based on identifying the designated call word 820.

In a state 805, the electronic device 100 according to an embodiment may change the direction of the electronic device 100 in a direction 812 in which one surface (e.g., a front surface) of the electronic device 100 faces from the electronic device 100 to the user 810. For example, the electronic device 100 may change the direction of the electronic device 100 towards a direction set to obtain a voice signal through the first microphone among the plurality of microphones placed in different directions. For example, an operation in which the electronic device 100 changes the direction of the electronic device may be included in a beamforming operation. However, an embodiment is not limited thereto.

As described above, the electronic device 100 according to an embodiment may perform beamforming toward a location, at which the call word 820 is generated, based on identifying the call word 820, thereby improving the accuracy of speech recognition for a continuous word to be uttered from the user 810 after the call word 820.

Referring to FIG. 8B, in a state 850, if the user 810 who uttered the call word 820 moves in a movement direction 851, the electronic device 100 according to an embodiment may obtain a continuous word 855 (or a plurality of voice signals indicating a continuous word) by using all of the plurality of microphones while tracking a movement path of the user 810.

As described above, the electronic device 100 according to an embodiment may obtain the continuous word 855 with the enhanced target voice by changing the direction and/or location of the electronic device 100 based on identifying the call word. While the user 810 is moving, the electronic device 100 may change the location (or direction) of the electronic device 100 along the user 810, thereby improving the accuracy of speech recognition service.

FIG. 9 shows an example of a flowchart for describing a method performed by an electronic device, according to an embodiment of the present disclosure. Hereinafter, as an example case, it can be assumed that the electronic device 100 of FIG. 1 performs a process of FIG. 9. In addition, in a description of FIG. 9, it may be understood that an operation described as being performed by a device can be controlled by the processor 110 of the electronic device 100. Each of the operations in FIG. 9 may be performed sequentially, but is not necessarily sequentially performed. For example, the order of operations may be changed, and at least two operations may be performed in parallel.

Referring to FIG. 9, in operation S910, a method according to an embodiment may include an operation of obtaining a plurality of voice signals by using a plurality of microphones.

For example, the plurality of voice signals may be expressed as channels based on the number of microphones. For example, if the number of microphones is four, the method may include an operation of obtaining a plurality of voice signals based on multiple channels.

Referring to FIG. 9, in operation S920, a method according to an embodiment may include an operation of identifying a designated call word, by performing speech recognition on a first voice signal, which is obtained from a first microphone, from among the plurality of voice signals according to a passage of time in obtaining the plurality of voice signals.

For example, the method may include bypassing speech recognition on other voice signals distinguished from the first voice signal among the plurality of voice signals while performing speech recognition on the first voice signal.

For example, the operation of identifying the designated call word may include an operation of removing an echo signal included in the first voice signal.

For example, the echo signal may indicate acoustic feedback between a speaker and a microphone.

For example, the operation of identifying the designated call word may include an operation of removing an echo signal by applying at least one filter (e.g., the acoustic echo cancellation 201 in FIG. 2) to the first voice signal.

For example, the operation of identifying the designated call word may include an operation of removing the residual echo and/or noise after removing the echo signal from the first voice signal.

Referring to FIG. 9, in operation S930, a method according to an embodiment may include an operation of obtaining, determining, calculating, or identifying a second time point preceding an utterance time corresponding to the designated call word from a first time point at which the designated call word is identified completely. The utterance time corresponding to the designated call word may be changed depending on the length of text included in the designated call word.

Referring to FIG. 9, in operation S940, a method according to an embodiment may include an operation of performing speech recognition on one portion, which can be obtained from the second time point, from among the plurality of voice signals. For example, the method may include an operation of performing rollback on a plurality of data sets corresponding to the plurality of voice signals based on identifying the designated call word.

For example, the method may include an operation of performing rollback on the plurality of data sets based on information obtained before identifying the designated call word.

For example, the method may include an operation of temporarily buffering other data sets corresponding to other voice signals distinct from the first voice signal among the plurality of voice signals while identifying the call word by using the first data set corresponding to the first voice signal.

For example, the method may include an operation of obtaining the plurality of data sets rolled back by performing rollback on all other buffered data sets and first data sets.

For example, the one portion obtained from the second time point may include text data corresponding to an input (e.g., a call word) for activating a speech recognition function and text data corresponding to an input (e.g., a continuous word) for the user to receive a speech recognition function.

For example, an operation of performing speech recognition on the one portion obtained from the second time point may include an operation of changing the location (or direction) of the electronic device according to the changed source location if source locations of the plurality of voice signals are changed.

The above description is merely an example of some technical ideas of the present disclosure, and various modifications and modifications may be made by one skilled in the art without departing from scopes of the present disclosure.

Accordingly, example embodiments of the present disclosure are intended not to limit but to explain technical ideas of the present disclosure, and scopes and spirit of the present disclosure are not necessarily limited by the above example embodiments. The scopes of protection of the present disclosure can be construed by the attached claims, and all equivalents thereof can be construed as being included within the scopes of the present disclosure.

The present technology of an embodiment may identify a call word by using at least one microphone among a plurality of microphones.

The present technology of an embodiment may perform speech recognition by using all of the plurality of microphones if a call word is identified.

The present technology of an embodiment may change a location of the electronic device based on a location where the call word occurs.

Hereinabove, although the present disclosure was described with reference to example embodiments and the accompanying drawings, the present disclosure is not necessarily limited thereto, but may be variously modified and altered by those skilled in the art to which the present disclosure pertains without departing from the spirit and scopes of the present disclosure claimed in the following claims.

What is claimed is:

1. An electronic device comprising:
a plurality of microphones including a first microphone;
a speaker;
one or more processors; and
a storage medium storing computer-readable instructions that, when executed by the one or more processors, enable the one or more processors to:
obtain a plurality of voice signals via the plurality of microphones,
identify a designated call word, by performing speech recognition on a first voice signal obtained from the first microphone, from among the plurality of voice signals according to a passage of time in obtaining the plurality of voice signals,
obtain a second time point, wherein the second time point precedes an utterance time corresponding to the designated call word, based on a first time point, wherein the first time point corresponds to the designated call word being identified completely, and
perform speech recognition on one portion, obtained starting after the second time point, from among the plurality of voice signals.

2. The device of claim 1, wherein the instructions further enable the one or more processors to:
track a location of a user associated with the plurality of voice signals by using a phase difference between the plurality of voice signals based on the performing of speech recognition on the one portion; and
identify a second voice signal, wherein the second voice signal is obtained by enhancing a target voice corresponding to an utterance of the user, from the plurality of voice signals obtained by performing beamforming toward the location of the user by using the plurality of microphones.

3. The device of claim 2, wherein the instructions further enable the one or more processors to:
identify a noise signal included in the second voice signal based on the identifying of the second voice signal; and
reduce amplitude of the noise signal.

4. The device of claim 2, wherein the instructions further enable the one or more processors to:
identify a target voice signal indicating the target voice based on the identifying of the second voice signal;
increase amplitude of the target voice signal included in the second voice signal; and
perform speech recognition by using the second voice signal with the increased amplitude of the target voice signal.

5. The device of claim 2, wherein the instructions further enable the one or more processors to:
reduce amplitude of a reference signal in each of the plurality of voice signals including the reference signal output from the speaker; and
track the location of the user by using the phase difference between the plurality of voice signals with the reduced amplitude of the reference signal.

6. The device of claim 1, wherein the instructions further enable the one or more processors to:
identify a reference signal indicating designated text, and identify a noise signal distinguished from the reference signal within the first voice signal;
reduce amplitude of one of or both of the reference signal and the noise signal; and
identify the designated call word by using the first voice signal with the reduced amplitude of one of or both of the reference signal and the noise signal.

7. The device of claim 1, wherein the instructions further enable the one or more processors to bypass speech recognition on other voice signals distinguished from the first voice signal among the plurality of voice signals while performing speech recognition on the first voice signal obtained from the first microphone.

8. The device of claim 7, wherein the instructions further enable the one or more processors to:
perform speech recognition on the first voice signal by using a first data set corresponding to the first voice signal; and
temporarily stop deletion of other data sets corresponding to the other voice signals based on a designated data size while bypassing speech recognition on the other voice signals.

9. The device of claim 8, wherein the instructions further enable the one or more processors to:
identify text data corresponding to the designated call word from the first data set;
obtain the second time point by performing rollback on the first data set and rollback on the other data sets based on the identified text data; and
perform speech recognition by using the first data set and all of the other data sets from the second time point.

10. The device of claim 1, wherein the instructions further enable the one or more processors to:
identify the first microphone among the plurality of microphones based on a distance from a user associated with the plurality of voice signals; and
obtain the first voice signal by using the first microphone.

11. A method comprising:
obtaining a plurality of voice signals using a plurality of microphones, wherein the plurality of microphones includes a first microphone;
identifying a designated call word, by performing speech recognition on a first voice signal obtained from the first microphone, from among the plurality of voice signals according to a passage of time in obtaining the plurality of voice signals;
obtaining a second time point, wherein the second time point precedes an utterance time corresponding to the designated call word, based on a first time point, wherein the first time point corresponds to the designated call word being identified completely; and
performing speech recognition on one portion, obtained starting after the second time point, from among the plurality of voice signals.

12. The method of claim 11, wherein the performing of the speech recognition on the one portion further comprises:
tracking a location of a user associated with the plurality of voice signals by using a phase difference between the plurality of voice signals based on the performing of speech recognition on the one portion; and
identifying a second voice signal, wherein the second voice signal is obtained by enhancing a target voice corresponding to an utterance of the user, from the plurality of voice signals obtained by performing beamforming toward the location of the user using the plurality of microphones.

13. The method of claim 12, wherein the identifying of the second voice signal comprises:
identifying a noise signal included in the second voice signal; and
reducing amplitude of the noise signal.

14. The method of claim 12, wherein the identifying of the second voice signal comprises:
identifying a target voice signal indicating the target voice;
increasing amplitude of the target voice signal included in the second voice signal; and
performing speech recognition using the second voice signal with the increased amplitude of the target voice signal.

15. The method of claim 12, wherein the tracking of the location of the user comprises:
reducing amplitude of a reference signal in each of the plurality of voice signals including the reference signal output from a speaker; and
tracking the location of the user by using the phase difference between the plurality of voice signals with the reduced amplitude of the reference signal.

16. The method of claim 11, wherein the identifying of the designated call word comprises:
identifying a reference signal indicating designated text within the first voice signal;
identifying a noise signal distinguished from the reference signal within the first voice signal;
reducing amplitude of one of or both of the reference signal and the noise signal; and
identifying the designated call word using the first voice signal with the reduced amplitude of one of or both of the reference signal and the noise signal.

17. The method of claim 11, further comprising bypassing speech recognition on other voice signals distinguished from the first voice signal among the plurality of voice signals while performing speech recognition on the first voice signal obtained from the first microphone.

18. The method of claim 17, wherein the bypassing of the speech recognition on the other voice signals comprises:
performing speech recognition on the first voice signal by using a first data set corresponding to the first voice signal; and
temporarily stopping deletion of other data sets corresponding to the other voice signals based on a designated data size during the bypassing of the speech recognition on the other voice signals.

19. The method of claim 18, further comprising:
identifying text data corresponding to the designated call word from the first data set;
obtaining the second time point by performing rollback on the first data set and rollback on the other data sets based on the identified text data; and
performing speech recognition by using the first data set and all of the other data sets from the second time point.

20. The method of claim 11, further comprising:
identifying the first microphone among the plurality of microphones based on a distance from a user associated with the plurality of voice signals; and
obtaining the first voice signal using the first microphone.
